(19) United States
(12) Patent Application Publication
(10) Pub. No.: US 2025/0037066 A1
(43) Pub. Date: Jan. 30, 2025

(54) OPTIMIZING BATTERY DELIVERY AND REPLACEMENT

(71) Applicant: Caterpillar Inc., Peoria, IL (US)

(72) Inventors: Christopher Ha, Champaign, IL (US); Sridhar Ramaswamy, Bolingbrook, IL (US); Sadia Khalil, Peoria, IL (US); Christopher Green, Cambridgeshire (GB); Damon Fielding, Corby Glen (GB); Sara Feetham, Peterborough (GB); Philippe Tuckmantel, Palo Alto, CA (US); Daryl Jones, Peterborough (GB); Diana Huerta, Chicago, IL (US); Mark Rodriguez, Orlando, FL (US); Glen Almgren, Johnstown, CO (US)

(21) Appl. No.: 18/361,742

(22) Filed: Jul. 28, 2023

(51) Int. Cl. G06Q 10/0833; B60L 53/80; B60L 58/16

(52) U.S. Cl. CPC G06Q 10/0833; B60L 53/80; B60L 58/16; G06Q 10/06315; G06Q 10/083; G06Q 10/087; G06Q 10/20

(57) ABSTRACT

The system obtains SOH of a first component, where the SOH indicates a difference between a current state of the first component and a state of a rated new component. The system obtains historical use of the first component. Based on the SOH and the historical use, the system determines a future SOH of the first component. The system obtains an indication of a requested SOH of the first component. Based on the indication of the requested SOH and the future SOH of the first component, the system determines a first time indicating when the first component will need to be replaced. The system determines a second time indicating when the second component is available to replace the first component, where the second time occurs before the first time. The system requests a delivery of the second component when the second time is substantially close to the first time.

### BACKGROUND

Heavy equipment used in construction, such as front loaders, backhoes, cranes, excavators, etc., can be powered by a battery which can be recharged. Over the life of the battery, which can last several years, the energy provided by the battery can decrease, and the heavy equipment may need to have the battery replaced. The battery is replaced in a specialized shop, which can take the heavy equipment out of operation, stalling the construction in progress. Consequently, the time required to replace the battery needs to be reduced, which includes ensuring that the new battery is available at the time when the heavy equipment is ready for battery replacement. In addition, the battery supply chain management needs to be optimized to deliver the appropriate battery and to reduce the time a new battery is waiting on the shelf for installation.

### SUMMARY

State of Health (SOH) is a battery health indicator which starts at 100% and decreases with time and battery usage. Users of the system employ earthmoving equipment for various application, and heavier application requires healthier battery (e.g., higher SOH). The SOH can be grouped into two or more categories indicating the battery health. User of the system can request a particular category. For instance, “Premium” category, e.g. subscription, is used for assets that generally perform the heaviest tasks and require the healthiest battery (e.g. minimum SOH of 95%). “Standard” category is used for assets that conduct the medium level of tasks that require less healthy battery (e.g., SOH of 90%). And finally, “Economy” category is used for the least demanding tasks that require the least healthy battery (e.g., SOH of 85%). Below a certain level of SOH (e.g., 85%), the battery no longer supports Earthmoving equipment's application.

The heathiest battery can satisfy requests for “Standard” and “Economy” batteries. However, using the heathiest battery for “Economy” subscription is not cost effective.

One of the key ingredients to optimize the battery supply chain management is accurately estimating/predicting the demands profile of the replacement batteries. The demand of a machine can be forecasted by predicting remaining days for the machine to reach the minimum SOH level for the machine's subscription. To do this, a battery degradation is simulated on future application profile, which is based on the historical machine sensor data.

Once the demand profile is estimated, then disclosed supply chain optimization and simulation techniques are adopted to determine the optimal battery inventory level while meeting customer's demand of the replacement battery to minimize down time at a desired service level (e.g. <0.5%).

The optimization and simulation approach (swaptimizer) is fully automated and conducted at the end-to-end supply chain network (from battery manufacturers to customers and all facilities in between) level to determine when and how many new battery to order and when and which battery should be replaced for which machine. It not only considers uncertainty associated with manufacturing, transportation, and replacement time but live feedback from real time supply chain operating changes. As mentioned earlier, the objective is to reduce overall operating costs including all associated activities of the supply chain management as well as inventory costs.

To do this, the system adopts a fully-coupled digital twin approach. The system creates a digital twin of an asset's life cycle as well as a digital twin of multiple assets' life cycle in a supply chain network.

### BRIEF DESCRIPTION OF THE DRAWINGS

Detailed descriptions of implementations of the present invention will be described and explained through the use of the accompanying drawings.

FIG. 1 shows a simulation of battery deliveries from manufacturers to users across the globe.

FIG. 2 shows various battery categories.

FIG. 3 shows a system to optimize battery delivery and replacement.

FIG. 4 is a flowchart of a method to optimize battery delivery and replacement.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Optimizinq Battery Delivery and Replacement

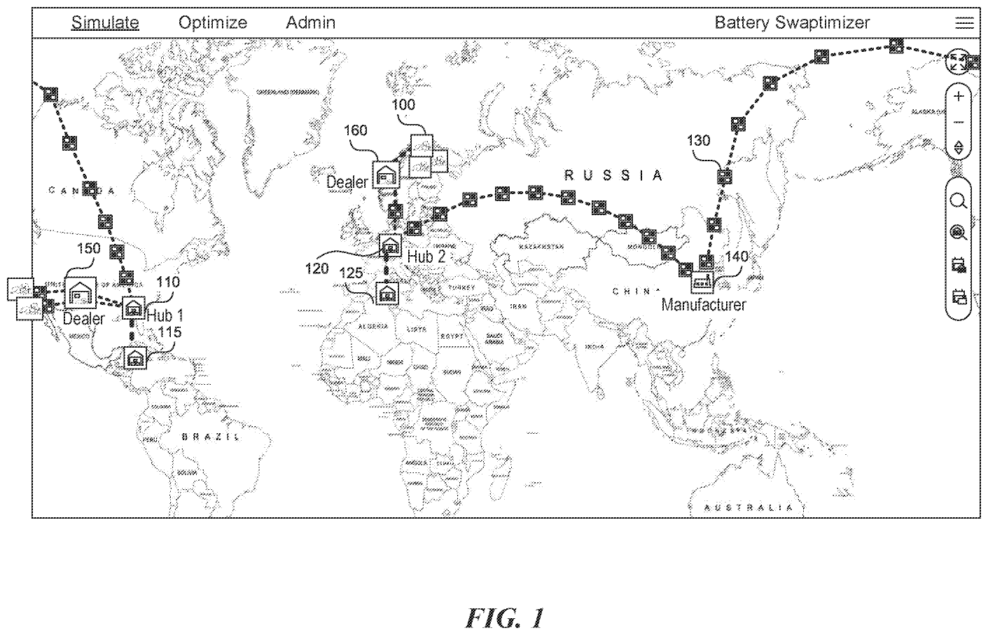

FIG. 1 shows a simulation of battery deliveries from manufacturers to users across the globe. Vehicles 100 (only one labeled for brevity) such as electric earthmoving equipment can operate on rechargeable batteries 130 (only one labeled for brevity). Once the battery 130 loses energy and capacity level to provide sufficient backup energy to the vehicle 100, the battery needs to be replaced. The replacement can be done at replacement locations 150, 160 (“dealers”), located in various places across the globe.

The dealers, 150, 160 however, do not manufacture the batteries, so they need to have the batteries delivered from a manufacturer 140. To deliver the batteries to the dealers 150, 160 the manufacturer 140 delivers the batteries to the hubs 110, 120. The battery 130 can be a single battery or a battery pack. The battery pack is a set of any number of (preferably) identical batteries or individual battery cells. They may be configured in a series, parallel or a mixture of both to deliver the desired voltage, capacity, or energy density. The hubs 110, 120 can have nearby repurpose facilities 115, 125 that can disassemble the used battery packs to the module level, e.g. single battery level, and reassemble the modules to create new battery packs. In a fashion, the repurpose facilities 110, 125 can re-manufacture the batteries. In addition, waste disposal facilities 170, 180 can receive used batteries and dispose of them.

In addition, the hubs have limited storage space and do not want to store unneeded batteries. Consequently, the hubs 110, 120 request delivery of batteries 130 when the vehicle 100 is likely to need a replacement battery. The in-use vehicles 100 can be located in various places, apart from the dealers 150, 160, and delivering the vehicles 100 to the appropriate dealer 150, 160 for battery replacement can take hours, days, or even weeks.

The dealers 150, 160 install the replacement batteries 130 according to first in, first out (FIFO) method. That is, the batteries 130 that are received first are also the first to be installed in vehicles 100. Later received batteries are installed in the vehicles later. In other words, the batteries 130 are installed in vehicles 100 according to the chronological order of receipt, starting with the earliest received batteries.

In addition, the replacement batteries 130 can vary based on the needs of the vehicle. For example, the replacement battery 130 for the vehicle 100 can be an already used battery, as further described below.

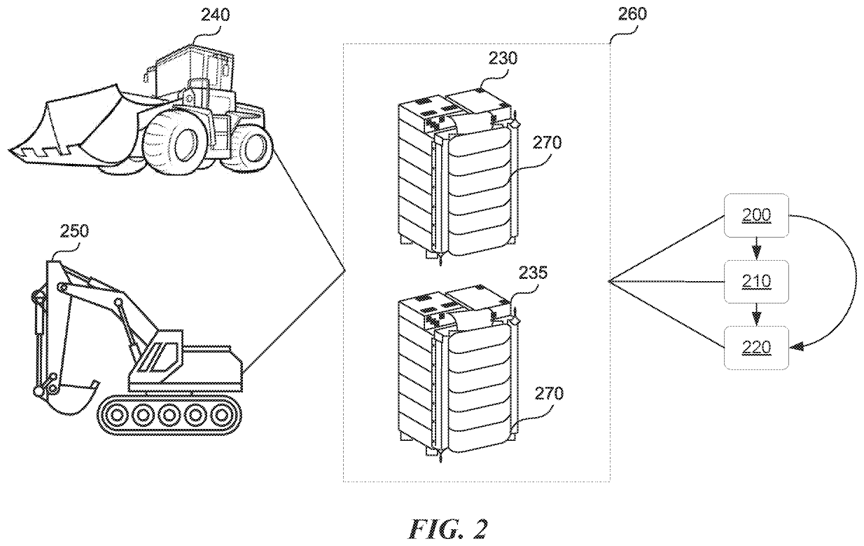

FIG. 2 shows various battery categories. Each battery 130 in FIG. 1 has an SOH that is the capability of the battery to retain charge at the current time compared to its rated value. A battery 130, when new, has the highest SOH because it can charge to 100%. As battery 130 ages, the battery's SOH steadily decreases and the battery can only be charged to 90%, then 80%, etc.

The battery 130 can be categorized into multiple categories 200, 210, 220 indicating the battery's SOH. SOH is the state of health. SOH is determined based on maximum range of state of charge (SOC) the battery can experience.

For example, the first category 200, e.g. “Premium” subscription, can be the highest and can indicate that the battery 130 SOH is in the highest range, such as between 100% and 92%. In other words, “Premium” subscription requires battery's SOH to be at least 92% when it is in the vehicle. However, when the battery is installed, the battery's SOH should be near 100% (maybe at least 99%) so the battery 130 can stay in the vehicle for some time, e.g. 1-2 years, before requiring a replacement. However, each battery 130 can have a single SOH at a given time.

The second category 210 can be the second highest and can indicate that the battery 130 SOH is between 92% and 85%. The third category 220 can be the lowest and can indicate that the battery 130 SOH is between 85% and 70%. Consequently, the battery 130 can start in the first category 200, then as the SOH of the battery decreases, the battery can move to the second category 210, and finally to the third category 220. The battery 130, however, cannot move up through the categories. Normally, SOH over time looks like an S-curve where after a certain value, SOH suddenly drops, and the battery should be considered a scrap/recycled battery. Once the battery does not satisfy the criteria for the lowest category 220, the battery is not reused anymore and can be thrown out and/or recycled.

In this application, the battery 130 can refer to a single battery 270, battery pack 230, 235 or a battery group 260. Each battery pack 230, 235 is made up of multiple single batteries 270. For example, one battery pack 230, 235 can include twelve single batteries 270. The battery group 260 includes multiple battery packs 230, 235. Some machines, such as a medium wheel loader, require the battery group 260, such as a battery group including five battery packs 230, 235. On the other hand, a small wheel loader needs only a single battery pack 230, 235 that includes six batteries 130.

SOH can be monitored at a battery pack 230, 235 level when the battery group 260 is outside of vehicle 240, 250. When the battery group 260 is included in the vehicle 240, 250, a single SOH can represent for all five battery packs for the medium wheel loader.

The vehicles 240, 250 may need to replace one or more batteries 130 in the battery pack 230 because one or more batteries 130 in the battery pack SOH do not meet the requested SOH needed by the vehicles 240, 250.

Different vehicles 240, 250 can have different battery demands. For example, the vehicle 240 may request that the battery 130 be in the first category 200 because the vehicle 240 may need high energy. The vehicle 250 may request that the battery 130 be in the second category 210 because the vehicle 250 may not need such high energy. Consequently, when the battery 130 in the vehicle 240 is categorized in the second category 210, the battery 130 can be provided to the vehicle 250.

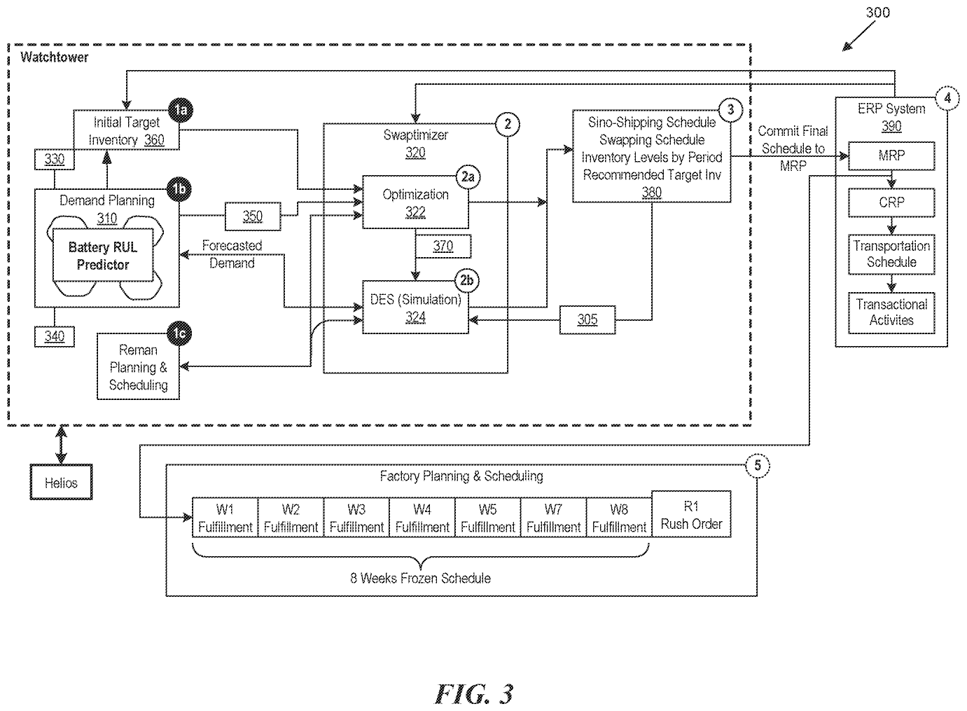

FIG. 3 shows a system to optimize battery delivery and replacement. The system 300 can include a battery remaining useful life (RUL) predictor 310 (“predictor”) and a swapping optimizer 320 (“swaptimizer”).

The predictor 310 can create a digital twin of the battery 130 in FIGS. 1, 2. In other words, the predictor 310 can adopt a digital twin approach to simulate a life cycle of a battery by leveraging a physics-based degradation model that uses vehicle's real-time and historical battery system sensor data. Specifically, the predictor 310 has two parts. First part includes a simulation model that can estimate the SOH degradation of battery based on current measurement. The second part includes predicting remaining battery life for a target SOH using estimated future battery usage profile based on historical battery operation.

To execute the first part, the predictor 310 can receive the current measurements 330 of the battery 130 performance from a sensor installed with the battery 130 operating a vehicle. To execute the second part, the predictor 310 can receive information about a historical use 340 of the battery 130, such as how many hours a day the battery 130 is powering the vehicle and/or how much energy is drained from the battery. Based on the historical use 340 and the current measurements 330, the predictor 310 can determine a future SOH associated with the battery 130 and a forecasted demand (“demand”) 350. The demand 350 can include the amount of batteries and the type of batteries required at a certain time. For example, the demand 350 can indicate the time when the battery will need to be replaced. In another example, the demand 350 can indicate that two batteries are needed next week, one battery in the highest SOH category, and one battery in the second highest SOH category.

The time component of the demand 350 can include an uncertainty quantification, such as an uncertainty time window which indicates by how much the time can change. The uncertainty time window can increase or decrease the time by one or more days or one or more weeks. The uncertainty time window can impact the demand 350. For example, if the time indicates the battery will be needed in two months, however the uncertainty time window indicates that the battery might be needed a month earlier, the demand 350 is adjusted to request the new battery in one month.

The predictor 310 can generate the target inventory 360 based on the demand 350 and lead time. The lead time indicates the length of time to deliver a replacement battery.

The swapping optimizer 320 can include the optimizer 322 and the discrete event simulator (DES) 324. The swapping optimizer 320 can receive as inputs the demand 350 indicating when the battery 130 will need to be replaced and the target inventory 360 which indicates how many batteries in each category 200, 210, 220 in FIG. 2 should be stored at the hub 110, 120 in FIG. 1. Based on the target inventory 360 and the demand 350, the optimizer 322, using mixed integer programming, can determine a weekly schedule 370 specifying when new batteries need to be delivered. The new batteries include the batteries in the highest category SOH. The discrete event simulator 324 can receive the weekly schedule 370 and can determine a daily schedule 380 which indicates how many batteries in each category 200, 210, 220 to distribute to which dealers each day. Both weekly schedule 370 and daily schedule 380 can also include an uncertainty time window extending over one or more days or one or more weeks.

The discrete event simulator 324 can simulate the inventory of the batteries 130, such as how many batteries are being delivered from the manufacturer, how many batteries are going out to hubs and dealers, how many batteries are being returned from the users and dealers to the hubs, and how many batteries are going from the dealers to the users that are requesting a lower category battery. The discrete event simulator 324 can create a simulation predicting delivery schedules years in the future, e.g., two years in the future.

The swapping optimizer 320 can send the daily schedule 380 to a third party 390 such as the manufacturer 140 in FIG. 1 and/or the deliverer. Upon delivery, the swapping optimizer 320 can receive feedback 305 indicating whether the delivery of the battery was timely. If the delivery of the battery was not timely, the swapping optimizer 320 can adjust the target inventory 360 and/or can increase the uncertainty quantification.

By determining the appropriate delivery schedule, the system 300 determines and maintains the target inventory 360. Further, the system 300 provides replacement batteries before they are needed, without the need to purchase them far in advance and store unneeded batteries for an unreasonably long time.

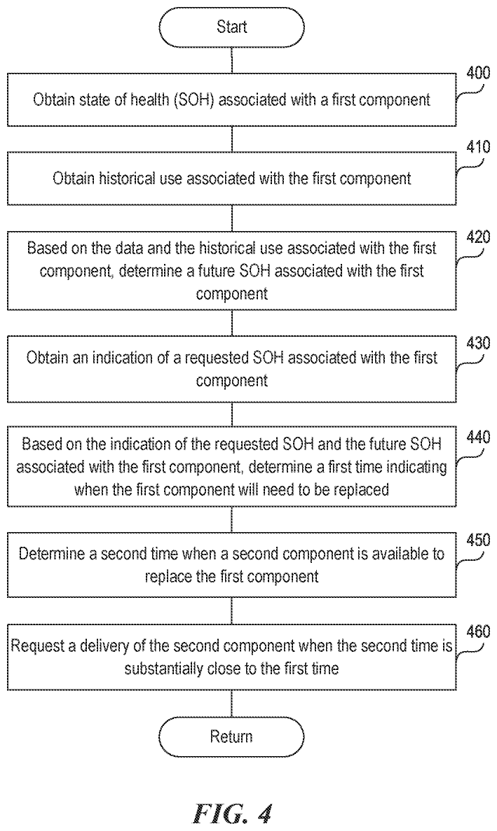

FIG. 4 is a flowchart of a method to optimize battery delivery and replacement. A hardware or software processor executing instructions described in this application can, in step 400, obtain SOH associated with a first component operating a vehicle. The first component can be a battery operating a vehicle such as earthmoving equipment. The SOH indicates a difference between a current state of the first component and a state of a rated new component. For example, the SOH can indicate capability of the first component to retain charge compared to the component's rated value that is obtained when the component is new. For example, the SOH is 100% when the battery is new, and it degrades over time. The processor can obtain the SOH from a sensor installed along with the first component.

In step 410, the processor can obtain historical use associated with the first component, such as how many hours a day the first component is used, for how many days a week, how frequently the first component needs to be replenished such as recharged, etc.

In step 420, based on the SOH and the historical use associated with the first component, the processor can determine a future SOH associated with the first component. To determine the future SOH, the processor can run a simulation of the operation of the first component based on the SOH measurements received from the sensor and based on the expected use associated with the first component.

In step 430, the processor can obtain an indication of a requested SOH associated with the first component. The requested SOH is the SOH that a system using the first component is requesting.

In step 440, based on the indication of the requested SOH and the future SOH associated with the first component, the processor can determine a first time indicating when the first component will need to be replaced. For example, the processor can determine that the first time is 500 days, a year, or 6 months from now.

In step 450, the processor can determine a second time indicating when the second component is available to replace the first component, where the second time occurs before the first time. For example, the processor can continually monitor the first time, and ensure that there is a second component that is available at the second time occurring before the first time. If the first time is predicted to occur in 6 months, the processor can determine whether there is any local inventory meeting the requested SOH. If there is no local inventory, the processor can determine a delivery time to obtain the component with the requested SOH, such as in 4 months. The delivery time can include an uncertainty quantification such as plus or minus a month. Based on the uncertainty quantification and the delivery time, the processor can determine that the second time is 5 months from now.

In step 460, the processor can request a delivery of the second component when the second time is substantially close to the first time, such as within hours, days, or weeks of the first time. For example, if the delivery time is 5 months from now, and the second component will be needed 6 months from now, the processor can request the delivery of the second component to occur 6 months from now at the latest.

The processor can categorize the SOH associated with the first component into multiple categories including a first category and a second category. The first component can initially be categorized in the first category and subsequently in the second category; however, the first component cannot be initially categorized in the second category and subsequently in the first category. In other words, the first category represents the highest performance, and the first component performance can only degrade over time, not improve over time. Generally, the disclosed system can order from the manufacturer only components in the first category. The components in the second category, the third category, etc. are obtained through using the first component.

The processor can obtain the indication of the requested SOH associated with the first component where the requested SOH can include the first category, the second category, the third category, etc. To initialize the whole process, the disclosed system can obtain multiple first components rated in the first category. In that case, even though the requested SOH of the first component is in the second category, the system can provide the first component having SOH in the first category, because there are no first components that have already been used.

For example, the requested SOH can indicate the second category, meaning an already used first component. The processor can determine the second time indicating when the second component is available to replace the first component using the following four steps. First, the processor can obtain the SOH associated with the second component, where the SOH associated with the second component indicates the first category. Second, the processor can determine a third time indicating when the second component will be categorized in the second category. Third, the processor can obtain a delivery speed from a location of the second component to a location of a replacement battery. Fourth, based on the third time and the delivery speed, the processor can determine the second time indicating when the second component is available to replace the first component.

The processor can create a fully-coupled digital twin approach. The system creates a first digital twin of the first component's life cycle as well as a second digital twin of multiple deliveries associated with multiple component in a supply chain network. The processor can determine the future SOH associated with the first component by creating a first digital twin of the first component including simulating degradation of the SOH associated with the first component based on the SOH and the historical use associated with the first component. The processor can create a second digital twin of multiple deliveries associated with multiple components by performing the following three steps. First, the processor can obtain multiple delivery schedules associated with multiple suppliers of the multiple components. Second, the processor can obtain multiple forecasted demands associated with the multiple components. Third, the processor can simulate multiple deliveries associated with the multiple components based on the multiple forecasted demands and the multiple delivery schedules.

To determine the second time indicating when the second component is available to replace the first component, the processor can obtain a location associated with the second component. The processor can obtain a location where the second component can replace the first component. The processor can determine a distance between the location associated with the second component and the location where the second component can replace the first component. The processor can obtain a delivery speed associated with the second component. Based on the distance between the location associated with the second component and the location where the second component can replace the first component, and the delivery speed, the processor can determine the second time indicating when the second component is available to replace the first component.

The processor can also provide uncertainty quantification and accommodate it. Specifically, based on the indication of the requested SOH and the future SOH associated with the first component, the processor can determine the first time indicating when the first component will need to be replaced and an uncertainty time window, where the uncertainty time window is an example of temporal uncertainty quantification. The uncertainty time window can indicate that the first time can be adjusted to an earlier or later time, such as an adjustment of several days, weeks, months, or years. The processor can request delivery of the second component when the second time matches the earlier time.

The processor can determine a shipping schedule. Specifically, the processor can obtain multiple times associated with multiple used batteries, where a time among the multiple times indicates when a used battery among the multiple used batteries needs to be replaced. The processor can obtain multiple delivery times associated with multiple replacement batteries. A delivery time among the multiple delivery times indicates when a replacement battery among the multiple replacement batteries can be delivered to a location where a replacement of the used battery with the replacement battery can occur. Based on the multiple times and the multiple delivery times, the processor can create a delivery schedule to the location where the replacement of the used battery with the replacement battery can occur. The processor can request a delivery of the multiple replacement batteries by providing the delivery schedule.

The processor can provide feedback on whether the first component was delivered on time. Specifically, the processor can obtain a delivery of the second component at a location configured to accommodate a replacement of the first component by the second component. The processor can determine whether the delivery of the second component occurred within a predetermined time window before the first component needed to be replaced. The predetermined time window can be a week, a day, or several hours. Upon determining that the delivery of the second component did not occur within the predetermined time window, the processor can provide feedback indicating that the delivery of the second component was not satisfactory.

### INDUSTRIAL APPLICABILITY

The disclosed system and method optimize battery delivery and replacement so that a user relying on the battery for operating construction equipment reduces the time that the construction equipment is out of operation. The system obtains a state of health (SOH) associated with a battery A operating a vehicle such as earthmoving equipment, where the SOH indicates capability of the battery A to retain charge compared to the battery's rated value. SOH is determined based on maximum range of state of charge (SOC) the battery can experience. The system obtains historical use associated with the battery A.

Based on the SOH and the historical use associated with the battery A, the system determines a future SOH associated with the battery A. In other words, the system determines the degradation of the battery's capacity over time. The system obtains an indication of a requested SOH associated with the vehicle. Based on the indication of the requested SOH and the future SOH associated with the battery A, the system determines a time A indicating when the vehicle will need a battery B. The system determines a time B indicating when the battery B is available to replace the battery A, where the time B occurs before the time A. The system requests a delivery of the battery B occurring when the time B is substantially close to the time A.

### Computer System

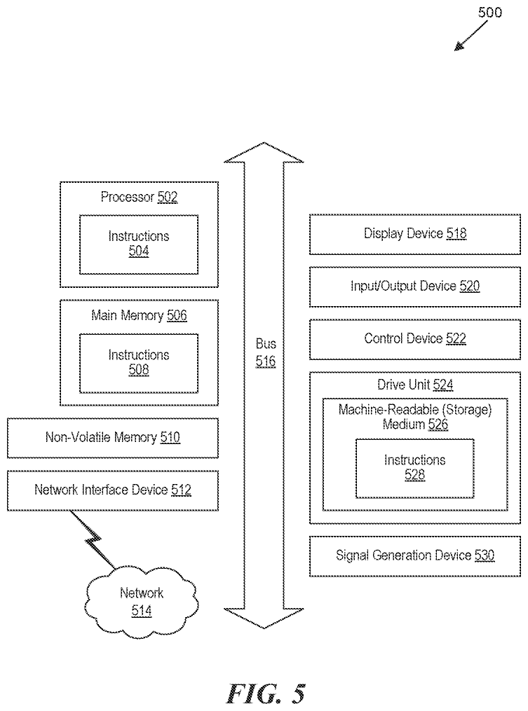

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC), or a distributed system such as a mesh of computer systems, or can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. At least one non-transitory computer-readable storage medium storing instructions, which, when executed by at least one data processor of a system, cause the system to:
obtain state of health (SOH) associated with a first battery operating a vehicle including earthmoving equipment,
wherein the SOH indicates capability of the first battery to retain charge compared to a rated value of the first battery;
obtain historical use associated with the first battery;
based on the SOH and the historical use associated with the first battery, determine a future SOH associated with the first battery;
obtain an indication of a requested SOH associated with the vehicle;
based on the indication of the requested SOH and the future SOH associated with the first battery, determine a first time indicating when the vehicle will need a second battery;
determine a second time indicating when the second battery is available to replace the first battery,
wherein the second time occurs before the first time; and
request a delivery of the second battery occurring when the second time is substantially close to the first time.

2. The at least one non-transitory computer-readable storage medium of claim 1, comprising instructions to:
categorize the SOH associated with the first battery into multiple categories including a first category and a second category,
wherein the first battery can be initially categorized in the first category and subsequently in the second category, and
wherein the first battery cannot be initially categorized in the second category and subsequently in the first category;
obtain the indication of the requested SOH associated with the vehicle,
wherein the requested SOH indicates the second category; and
determine the second time indicating when the second battery is available to replace the first battery by:
obtaining an SOH associated with the second battery operating a second vehicle,
wherein the SOH associated with the second battery operating the second vehicle indicates the first category;
determining a third time indicating when the second battery will be categorized in the second category;
obtaining a delivery speed from a location of the second battery to a location configured to accommodate the second battery replacing the first battery; and
based on the third time and the delivery speed, determining the second time indicating when the second battery is available to replace the first battery.

3. The at least one non-transitory computer-readable storage medium of claim 1, comprising instructions to:
determine the future SOH associated with the first component by creating a first digital twin of the first component including simulating degradation of the SOH associated with the first component based on the SOH and the historical use associated with the first component; and
create a second digital twin of multiple deliveries associated with multiple components by:
obtaining multiple delivery schedules associated with multiple suppliers of the multiple components;
obtaining multiple forecasted demands associated with the multiple components; and
simulating multiple deliveries associated with the multiple components based on the multiple forecasted demands and the multiple delivery schedules.

4. The at least one non-transitory computer-readable storage medium of claim 1, wherein the instructions to determine the second time indicating when the second battery is available to replace the first battery comprise instructions to:
obtain a location associated with the second battery;
obtain a location configured to accommodate the second battery replacing the first battery;
determine a distance between the location associated with the second battery and the location configured to accommodate the second battery replacing the first battery;
obtain a delivery speed associated with the second battery; and
based on the distance between the location associated with the second battery and the location configured to accommodate the second battery replacing the first battery and the delivery speed, determine the second time indicating when the second battery is available to replace the first battery.

5. The at least one non-transitory computer-readable storage medium of claim 1, comprising instructions to:
based on the indication of the requested SOH and the future SOH associated with the first battery, determine the first time indicating when the vehicle will need the second battery and an uncertainty time window,
wherein the uncertainty time window is configured to adjust the first time to an earlier time; and
request a delivery of the second battery when the second time matches the earlier time.

6. The at least one non-transitory computer-readable storage medium of claim 1, comprising instructions to:
obtain multiple times associated with multiple used batteries,
wherein a time among the multiple times indicates when a used battery among the multiple used batteries needs to be replaced;
obtain multiple delivery times associated with multiple replacement batteries,
wherein a delivery time among the multiple delivery times indicates when a replacement battery among the multiple replacement batteries can be delivered to a location where a replacement of the used battery with the replacement battery can occur;
based on the multiple times and the multiple delivery times, create a delivery schedule to the location where the replacement of the used battery with the replacement battery can occur; and
request a delivery of the multiple replacement batteries by providing the delivery schedule.

7. The at least one non-transitory computer-readable storage medium of claim 1, comprising instructions to:
obtain the delivery of the second battery at a location configured to accommodate a replacement of the first battery by the second battery;
determine whether the delivery of the second battery occurred within a predetermined time window before the first battery needed to be replaced; and
upon determining that the delivery of the second battery did not occur within the predetermined time window, provide feedback indicating that the delivery of the second battery was not satisfactory.

8. A method comprising:
obtaining state of health (SOH) associated with a first component
wherein the SOH indicates a difference between a current state of the first component and a state of a rated new component;
obtaining historical use associated with the first component;
based on the SOH and the historical use associated with the first component,
determining a future SOH associated with the first component;
obtaining an indication of a requested SOH associated with the first component;
based on the indication of the requested SOH and the future SOH associated with the first component, determining a first time indicating when the first component will need to be replaced;
determining a second time indicating when a second component is available to replace the first component,
wherein the second time occurs before the first time; and
requesting a delivery of the second component when the second time is substantially close to the first time.

9. The method of claim 8, comprising:
categorizing the SOH associated with the first component into multiple categories including a first category and a second category,
wherein the first component can be initially categorized in the first category and subsequently in the second category, and
wherein the first component cannot be initially categorized in the second category and subsequently in the first category;
obtaining the indication of the requested SOH associated with the first component,
wherein the requested SOH indicates the second category; and
determining the second time indicating when the second component is available to replace the first component by:
obtaining an SOH associated with the second component,
wherein the SOH associated with the second component indicates the first category;
determining a third time indicating when the second component will be categorized in the second category;
obtaining a delivery speed from a location of the second component to a location of a replacement battery; and
based on the third time and the delivery speed, determining the second time indicating when the second component is available to replace the first component.

10. The method of claim 8, comprising:
determining the future SOH associated with the first component by creating a first digital twin of the first component including simulating degradation of the SOH associated with the first component based on the SOH and the historical use associated with the first component; and
creating a second digital twin of multiple deliveries associated with multiple components by:
obtaining multiple delivery schedules associated with multiple suppliers of the multiple components;
obtaining multiple forecasted demands associated with the multiple components; and
simulating multiple deliveries associated with the multiple components based on the multiple forecasted demands and the multiple delivery schedules.

11. The method of claim 8, wherein determining the second time indicating when the second component is available to replace the first component comprises:
obtaining a location associated with the second component;
obtaining a location where the second component can replace the first component;
determining a distance between the location associated with the second component and the location where the second component can replace the first component;
obtaining a delivery speed associated with the second component; and
based on the distance between the location associated with the second component and the location where the second component can replace the first component and the delivery speed, determining the second time indicating when the second component is available to replace the first component.

12. The method of claim 8, comprising:
obtaining multiple times associated with multiple used batteries,
wherein a time among the multiple times indicates when a used battery among the multiple used batteries needs to be replaced;
obtaining multiple delivery times associated with multiple replacement batteries,
wherein a delivery time among the multiple delivery times indicates when a replacement battery among the multiple replacement batteries can be delivered to a location where a replacement of the used battery with the replacement battery can occur;
based on the multiple times and the multiple delivery times, creating a delivery schedule to the location where the replacement of the used battery with the replacement battery can occur; and
requesting a delivery of the multiple replacement batteries by providing the delivery schedule.

13. The method of claim 8, comprising:
obtaining a delivery of the second component at a location configured to accommodate a replacement of the first component by the second component;
determining whether the delivery of the second component occurred within a predetermined time window before the first component needed to be replaced; and
upon determining that the delivery of the second component did not occur within the predetermined time window, providing feedback indicating that the delivery of the second component was not satisfactory.

14. A system comprising:
at least one hardware processor; and
at least one non-transitory memory storing instructions, which, when executed by the at least one hardware processor, cause the system to:
obtain state of health (SOH) associated with a first component
wherein the SOH indicates a difference between a current state of the first component and a state of a rated new component;
obtain historical use associated with the first component;
based on the SOH and the historical use associated with the first component,
determine a future SOH associated with the first component;
obtain an indication of a requested SOH associated with the first component;
based on the indication of the requested SOH and the future SOH associated with the first component, determine a first time indicating when the first component will need to be replaced;
determine a second time indicating when a second component is available to replace the first component,
wherein the second time occurs before the first time; and
request a delivery of the second component when the second time is substantially close to the first time.

15. The system of claim 14, comprising instructions to:
determine the future SOH associated with the first component by creating a first digital twin of the first component including simulating degradation of the SOH associated with the first component based on the SOH and the historical use associated with the first component; and
create a second digital twin of multiple deliveries associated with multiple components by:
obtaining multiple delivery schedules associated with multiple suppliers of the multiple components;
obtaining multiple forecasted demands associated with the multiple components; and
simulating multiple deliveries associated with the multiple components based on the multiple forecasted demands and the multiple delivery schedules.

16. The system of claim 14, comprising instructions to:
categorize the SOH associated with the first component into multiple categories including a first category and a second category,
wherein the first component can be initially categorized in the first category and subsequently in the second category, and
wherein the first component cannot be initially categorized in the second category and subsequently in the first category;
obtain the indication of the requested SOH associated with the first component,
wherein the requested SOH indicates the second category; and
determine the second time indicating when the second component is available to replace the first component by:
obtaining an SOH associated with the second component,
wherein the SOH associated with the second component indicates the first category;
determining a third time indicating when the second component will be categorized in the second category;
obtaining a delivery speed from a location of the second component to a location of a replacement battery; and
based on the third time and the delivery speed, determining the second time indicating when the second component is available to replace the first component.

17. The system of claim 14, wherein instructions to determine the second time indicating when the second component is available to replace the first component comprise instructions to:
obtain a location associated with the second component;
obtain a location where the second component can replace the first component;
determine a distance between the location associated with the second component and the location where the second component can replace the first component;
obtain a delivery speed associated with the second component; and
based on the distance between the location associated with the second component and the location where the second component can replace the first component and the delivery speed, determine the second time indicating when the second component is available to replace the first component.

18. The system of claim 14, comprising instructions to:
based on the indication of the requested SOH and the future SOH associated with the first component, determine the first time indicating when the first component will need to be replaced and an uncertainty time window,
wherein the uncertainty time window is configured to adjust the first time to an earlier time; and
request delivery of the second component when the second time matches the earlier time.

19. The system of claim 14, comprising instructions to:
obtain multiple times associated with multiple used batteries,
wherein a time among the multiple times indicates when a used battery among the multiple used batteries needs to be replaced;
obtain multiple delivery times associated with multiple replacement batteries,
wherein a delivery time among the multiple delivery times indicates when a replacement battery among the multiple replacement batteries can be delivered to a location where a replacement of the used battery with the replacement battery can occur;
based on the multiple times and the multiple delivery times, create a delivery schedule to the location where the replacement of the used battery with the replacement battery can occur; and
request a delivery of the multiple replacement batteries by providing the delivery schedule.

20. The system of claim 14, comprising instructions to:
obtain a delivery of the second component at a location configured to accommodate a replacement of the first component by the second component;
determine whether the delivery of the second component occurred within a predetermined time window before the first component needed to be replaced; and
upon determining that the delivery of the second component did not occur within the predetermined time window, provide feedback indicating that the delivery of the second component was not satisfactory.
